(19) United States
(12) Patent Application Publication
(10) Pub. No.: US 2023/0027410 A1
(43) Pub. Date: Jan. 26, 2023

(54) BARRIER LAMINATE FILMS FOR LAP SEALS

(71) Applicant: Dow Global Technologies LLC, Midland, MI (US)

(72) Inventors: Shenglong Chen, Shanghai (CN); Xiaobing Yun, Shanghai (CN); Jianping Pan, Shanghai (CN); Jingyi Xu, Shanghai (CN); Jianliang Zhu, Shanghai (CN)

(73) Assignee: Dow Global Technologies LLC, Midland, MI (US)

(21) Appl. No.: 17/787,481

(22) PCT Filed: Dec. 20, 2019
(86) PCT No.: PCT/CN2019/126888

§ 371 Date: Jun. 20, 2022

(51) Int. Cl. B32B 15/085; B32B 7/12; B32B 15/088; B32B 15/09; B32B 15/20; B32B 27/08; B32B 27/32; B32B 27/34; B32B 27/36

(52) U.S. Cl. CPC B32B 15/085; B32B 7/12; B32B 15/088; B32B 15/09; B32B 15/20; B32B 27/08; B32B 27/32; B32B 27/34; B32B 27/36; B32B 27/16

(57) ABSTRACT

A multilayer laminate (100) comprises an oriented polyethylene film (102), a biaxially oriented film (104) adhered to the oriented polyethylene film (102), a barrier film (106) adhered to the biaxially oriented film (104), and a multilayer polyethylene (PE) film (108) adhered to the barrier film (106). The biaxially oriented film (104) comprises one or more components selected from biaxially oriented polyamide (BOPA), biaxially oriented polyethylene terephthalate (BOPET), and biaxially oriented polypropylene (BOPP).

### TECHNICAL FIELD

Embodiments of the present disclosure are generally related to multilayer films, and are more particularly related to multilayer films including oriented polyethylene films and barrier films.

### BACKGROUND

Multilayer films can include films such as cast films or blown films, which may be suitable for flexible packages such as sachets or pouches for various consumer products. Laminates used in some such applications have included biaxially-oriented polyethylene (BOPE). However, the speed at which printing of such films can be achieved is typically limited. Additionally, such films may lack the boiling resistance needed to survive high temperature sterilization processes that are used for some food products and/or the acid resistance needed for packaging medical products.

Accordingly, there remains a need for barrier laminate films having suitable boiling resistance and acid resistance.

### SUMMARY

The present disclosure meets these needs by providing multilayer laminates having an oriented polyethylene film, a biaxially oriented film adhered to the oriented polyethylene film as a print layer, a metal layer or metallized film as a barrier film, and a multilayer polyethylene film adhered to the barrier film. Such multilayer laminates, in some aspects, can exhibit improved boiling resistance and acid resistance compared to conventional multilayer laminates used for consumer product packaging applications.

According to at least one embodiment of the present disclosure, a multilayer laminate comprises an oriented polyethylene film, a biaxially oriented film adhered to the oriented polyethylene film, a barrier film adhered to the biaxially oriented film, and a multilayer polyethylene (PE) film adhered to the barrier film. The biaxially oriented film comprises one or more components selected from biaxially oriented polyamide (BOPA), biaxially oriented polyethylene terephthalate (BOPET), and biaxially oriented polypropylene (BOPP), and comprises ink. The barrier film comprises a metal layer, metallized film, or silica-coated film.

According to another embodiment of the present disclosure, the multilayer laminate comprises the multilayer laminate of the previous embodiment, wherein the multilayer laminate further comprises adhesive, the adhesive comprising one or more adhesives selected from solvent-based adhesive, solventless adhesive, and water-based adhesive.

According to another embodiment of the present disclosure, the multilayer laminate comprises the multilayer laminate of the previous embodiment, wherein the adhesive comprises solvent-based adhesive.

According to another embodiment of the present disclosure, the multilayer laminate comprises the multilayer laminate of any previous embodiment, wherein the barrier film comprises one or more components selected from aluminum foil, metallized polyethylene terephthalate (mPET), silica-coated polyethylene terephthalate (silica-coated PET), metallized oriented polypropylene (mOPP), and metallized cast polypropylene (mCPP).

According to another embodiment of the present disclosure, the multilayer laminate comprises the multilayer laminate of any previous embodiment, wherein the biaxially oriented film comprises BOPET.

According to another embodiment of the present disclosure, the multilayer laminate comprises the multilayer laminate of any previous embodiment, wherein the barrier film is a multilayer or monolayer film.

According to another embodiment of the present disclosure, the multilayer laminate comprises the multilayer laminate of any previous embodiment, wherein the barrier film comprises aluminum foil.

According to another embodiment of the present disclosure, the multilayer laminate comprises the multilayer laminate of any previous embodiment, wherein the multilayer PE film comprises at least one layer comprising low density polyethylene (LDPE) and linear low density polyethylene (LLDPE).

According to another embodiment of the present disclosure, the multilayer laminate comprises the multilayer laminate of any previous embodiment, wherein the multilayer PE film is a blown film.

According to another embodiment of the present disclosure, the multilayer laminate comprises the multilayer laminate of any previous embodiment, wherein the oriented polyethylene film comprises tenter frame biaxially oriented polyethylene (TF-BOPE) film.

According to another embodiment of the present disclosure, a flexible package comprises the multilayer laminate of any previous embodiment, wherein the flexible package comprises a lap seal, the lap seal comprising the oriented polyethylene film sealed to the multilayer PE film.

These and other embodiments are described in more detail in the following Detailed Description and the Drawings.

### BRIEF SUMMARY OF THE DRAWINGS

FIG. 1 is a schematic illustration of a multilayer laminate according to one or more embodiments shown and described herein; and

FIG. 2 is schematic illustration of the formation of a lap seal according to one or more embodiments shown and described herein.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer,” as used herein, refers to a polymer prepared by the polymerization of at least two different types of monomers. The generic term interpolymer thus includes copolymers, and polymers prepared from more than two different types of monomers, such as terpolymers.

“Polyethylene” or “ethylene-based polymer” shall mean polymers comprising greater than 50% by mole of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); Medium Density Polyethylene (MDPE); and High Density Polyethylene (HDPE).

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm.

The term “LLDPE” includes resin made using Ziegler-Natta catalyst systems as well as resin made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 to 0.945 g/cc. “MDPE” is typically made using chromium or Ziegler-Natta catalysts or using single-site catalysts including, but not limited to, bis-metallocene catalysts and constrained geometry catalysts.

The term “HDPE” refers to polyethylenes having densities greater than about 0.945 g/cc, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.909 g/cc, which are generally prepared with Ziegler-Natta catalysts, single-site catalysts including, but not limited to, bis-metallocene catalysts and constrained geometry catalysts, and post-metallocene, molecular catalysts. The term “propylene-based polymer,” as used herein, refers to a polymer that comprises, in polymerized form, refers to polymers comprising greater than 50% by weight of units which have been derived from propylene monomer. This includes propylene homopolymer, random copolymer polypropylene, impact copolymer polypropylene, propylene/a-olefin interpolymer, and propylene/a-olefin copolymer. These polypropylene materials are generally known in the art.

“Multilayer film” means any structure having more than one layer. For example, the multilayer structure may have two, three, four, five or more layers. A multilayer film may be described as having the layers designated with letters. For example, a three layer structure having a core layer B, and two external layers A and C may be designated as AB/C. Likewise, a structure having two core layers B and C and two external layers A and D would be designated A/B/C/D. Additionally, the skilled person would know that further layers E, F, G, etc. may also be incorporated into this structure.

The terms “flexible packaging” or “flexible packaging material” encompass various non-rigid containers familiar to the skilled person. These may include pouches, stand-up pouches, pillow pouches, or bulk bags, pre-made packages, or the like. Some typical end use applications for flexible packages are for snack, dry food, liquid, or cheese packages. Other end use applications include, but are not limited to, pet foods, snacks, chips, frozen foods, meats, hot dogs, medical products, and numerous other applications.

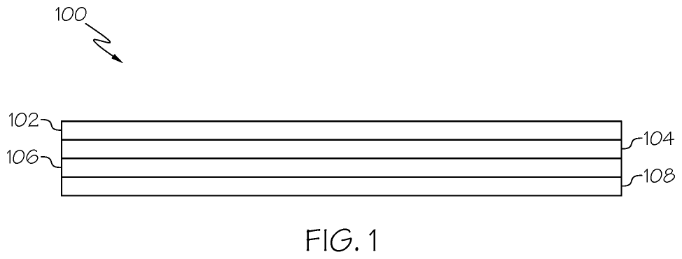

FIG. 1 illustrates an example multilayer laminate 100, wherein the multilayer laminate 100 comprises at least an oriented polyethylene film 102, a biaxially oriented film 104 adhered to the oriented polyethylene film 102, a barrier film 106 adhered to the biaxially oriented film 104, and a multilayer PE film 108 adhered to the barrier film 106. Various embodiments of the multilayer laminate 100 will now be made in detail.

Oriented polyethylene film

In various embodiments, the multilayer laminate 100 comprises an oriented polyethylene (PE) film 102. For example, the oriented PE film 102 may be biaxially oriented polyethylene (BOPE) or monoaxially oriented polyethylene, wherein the polyethylene is oriented in either the machine direction or cross direction.

In embodiments in which the oriented PE film 102 is BOPE, the BOPE may be biaxially oriented using a tenter frame sequential biaxial orientation process, and may referred to as tenter frame biaxially oriented polyethylene (TF-BOPE). Such techniques are generally known to those of skill in the art. In other embodiments, the polyethylene film can be biaxially oriented using other techniques known to those of skill in the art based on the teachings herein, such as double bubble or triple bubble orientation processes. In general, with a tenter frame sequential biaxial orientation process, the tenter frame is incorporated as part of a multilayer co-extrusion line. After extruding from a flat die, the film is cooled down on a chill roll, and is immersed into a water bath filled with room temperature water. The cast film is then passed onto a series of rollers with different revolving speeds to achieve stretching in the machine direction. There are several pairs of rollers in the MD stretching segment of the fabrication line, and are all oil heated. The paired rollers work sequentially as pre-heated rollers, stretching rollers, and rollers for relaxing and annealing. The temperature of each pair of rollers is separately controlled. After stretching in the machine direction, the film web is passed into a tenter frame hot air oven with heating zones to carry out stretching in the cross direction. The first several zones are for pre-heating, followed by zones for stretching, and then the last zones for annealing.

In embodiments herein, the polyethylene may have a density of 0.900 g/cc to 0.950 g/cc. All individual values and subranges of at least 0.900 g/cc to 0.950 g/cc are included and disclosed herein. For example, in some embodiments, the polyethylene has a density of 0.900 to 0.945 g/cc, 0.900 to 0.940 g/cc, 0.900 to 0.935 g/cc, 0.910 g/cc to 0.945 g/cc, 0.910 to 0.940 g/cc, 0.910 to 0.935 g/cc, 0.910 to 0.930 g/cc, 0.915 to 0.940 g/cc, 0.915 to 0.923 g/cc, or 0.920 g/cc to 0.935 g/cc. Density may be measured in accordance with ASTM D792.

In embodiments herein, the polyethylene may have a melt index, 12, measured in accordance with ASTM D1238 at 190° C. and 2.16 kg of 0.1 g/10 min to 10 g/10 min. All individual values and subranges of at least 0.1 g/10 min to 10 g/10 min are included and disclosed herein. For example, in some embodiments, the polyethylene may have a melt index, 12, of 0.1 g/10 min to 9.5 g/10 min, 0.1 g/10 min to 9.0 g/10 min, 0.1 g/10 min to 5 g/10 min, 0.5 g/10 min to 6 g/10 min, 1 g/10 min to 5 g/10 min, 1.5 g/10 min to 4.5 g/10 min, or 2 g/10 min to 4 g/10 min. In other embodiments, the polyethylene may have a melt index, I₂, of 0.7 g/10 min to 9.5 g/10 min, 0.7 g/10 min to 8 g/10 min, or 0.7 g/10 min to 5 g/10 min. Melt index, I₂, may be measured in accordance with ASTM D1238 (190° C. and 2.16 kg).

In embodiments herein, the polyethylene may have a melt flow ratio, 110/12, of less than 14. All individual values and subranges of less than 14 are included and disclosed herein. For example, in some embodiments, the polyethylene may have a melt flow ratio, I₁₀/I₂, of less than 13.5, 13, 12.5, 10, or even 7.5. In other embodiments, the polyethylene may have a melt flow ratio, I₁₀/I₂, of from 1.0 to 14, 2 to 14, 4 to 14, 5 to 14, 5.5 to 14, 6 to 14, 5 to 13.5, 5 to 13, 5 to 12.5, 5 to 12, 5 to 11.5, 5 to 11, 5.5 to 13.5, 5.5 to 13, 5.5 to 12.5, 5.5 to 12, 5.5 to 11.5, 5.5 to 11, 6 to 13.5, 6 to 13, 6 to 12.5, 6 to 12, 6 to 11.5, or 6 to 11. Melt index, I₁₀, may be measured in accordance with ASTM D1238 (190° C. and 10.0 kg).

Commercially available oriented polyethylene films suitable for use include, for example, TF-BOPE films available from Decro (Gunangdong, China). Commercial examples of suitable ethylene-based copolymers that can be used in such TF-BOPE films may include those sold under the trade names ATTANE™, DOWLEX™, ELITE™, ELITE AT™, and INNATE™ all available from The Dow Chemical Company (Midland, Mich.); LUMICENE® available from Total SA; and EXCEED™ and EXACT™ available from Exxon Chemical Company. The use of other commercially available mono- and bi-axially oriented films, as well as the use of other polyethylenes, are contemplated.

In some embodiments, the polyethylene film can be oriented in the machine direction at a draw ratio of 2:1 to 8:1, or in the alternative, at a draw ratio of 3:1 to 7:1. The polyethylene film, in some embodiments, can be oriented in the cross direction at a draw ratio of 2:1 to 11:1, or in the alternative, at a draw ratio of 3:1 to 10:1. In some embodiments, the polyethylene film is oriented in the machine direction at a draw ratio of 2:1 to 7:1 and in the cross direction at a draw ratio of 2:1 to 10:1.

Following orientation, the oriented polyethylene film 102 can exhibit a number of physical properties, such as good clarity and/or good gloss. In embodiments, the oriented polyethylene film 102 exhibits a clarity of greater than 75%, greater than 80%, greater than 85%, greater than 90%, or greater than 95%. Clarity is determined in accordance with ASTM D1746. In embodiments, the oriented polyethylene film 102 exhibits a gloss at 45° of greater than 25. For example, the oriented polyethylene film 102 may exhibit a gloss at 45 ° of 25 to 75, 25 to 70, 30 to 75, 30 to 70, 35 to 75, 35 to 70, 40 to 75, 40 to 70, 45 to 75, 45 to 70, 25 to 65, 25 to 60, 25 to 55, 25 to 50, 30 to 65, 30 to 60, 30 to 55, 30 to 50, 35 to 65, 35 to 60, 35 to 55, or 35 to 50. Gloss at 45° is determined in accordance with ASTM D2457-08/ASTM D1003-01.

In some embodiments, depending for example on the end use application, the oriented polyethylene film 102 can be corona treated using techniques known to those of skill in the art before or after lamination to the biaxially oriented film 104. Moreover, the oriented polyethylene film 102 may be a multi-layer film or a mono-layer film, depending on the particular embodiment.

Biaxially Oriented Film

According to various embodiments, a biaxially oriented film 104 is adhered to the oriented PE film 102. The biaxially oriented film 104 can be, for example, a biaxially oriented polyolefin film including polyolefins, such as high density polyethylene (HDPE), polyethylene (PE), polypropylene (PP), polyethylene terephthalate (PET), polyamides (PA), or combinations thereof. In embodiments, the biaxially oriented film 104 includes, for example, biaxially oriented terephthalate (BOPET), biaxially oriented polypropylene (BOPP), biaxially oriented polyamide (BOPA) or combinations thereof

In various embodiments, the biaxially oriented film 104 comprises ink. The ink may be, for example, in the form of images or words. In such embodiments, the ink may be printed on the biaxially oriented film 104. The biaxially oriented film 104 may undergo a printing process to have the ink printed thereon. Various printing processes are considered suitable and may include, by way of example and not limitation, rotogravure printing, flexographic printing, and offset printing.

Barrier Film

The multilayer laminate 100 of various embodiments includes a barrier film 106 adhered to the biaxially oriented film 104. In various embodiments, the barrier film 106 is a gas and moisture barrier comprising one or more metal-based layers, wherein the metal-based layers are metal layers or metallized film layers. The metal layer or metallized film layer can include, by way of example and not limitation, Al, Si, Zn, Au, Ag, Cu, Ni, Cr, Ge, Se, Ti, Sn, oxides thereof, and combinations thereof. In some embodiments, the metal or metal oxide is deposited on a polyethylene or polypropylene film to form the barrier film 106. For example, the barrier film 106 may be metallized polyethylene terephthalate (mPET), silica-coated polyethylene terephthalate (silica-coated PET), metallized oriented polypropylene (mOPP), or metallized cast polypropylene (mCPP). In some embodiments, the metal or metal oxide is in the form of a foil, such as an aluminum foil layer or a gold foil layer.

In embodiments in which the metal or metal oxide is deposited on a polyethylene or polypropylene film to form the barrier film, the metal or metal oxide may be deposited on the polyethylene or polypropylene film by vacuum metallization. Other methods for depositing the metal-based material on the film include those methods known and used in the art.

The barrier film 106 may be a multi-layer film or a mono-layer film, depending on the particular embodiment. In embodiments in which the barrier film 106 is a multi-layer film, each layer in the film can be selected for its ability to provide one or more types of barriers. For example, a first layer of the multi-layer film may be used to provide a gas barrier, and a second layer of the multi-layer film may be used to provide a moisture barrier. In some embodiments, more than one layer of the multi-layer film may provide barrier properties (e.g., the first and the second layer can provide a moisture barrier while the first layer also provides a gas barrier).

Multilayer PE Film

In various embodiments, a multilayer PE film 108 is adhered to the barrier film 106. In embodiments, the multilayer PE film 108 includes at least one layer comprising a linear low density polyethylene (LLDPE) and a low density polyethylene (LDPE). The LLDPE may help to provide enhanced mechanical performance (such as tear or dart) of the overall structure. The LDPE may help provide improved blending properties, enhanced melt stability, and/or improved bubble stability. One or more additional layers in the multilayer PE film 108 can each include an LLDPE, an LDPE, an ultra low density polyethylene (ULDPE), a very low density polyethylene (VLDPE), a medium density polyethylene (MOPE), a high density polyethylene (HDPE), or blends thereof

In some embodiments, the multilayer PE film 108 can include a plurality of layers comprising ethylene-based polymers, including LLDPEs, LDPEs, MDPEs, HDPEs, polyethylene plastomers, and polyethylene elastomers. For example, the layers can include a linear low density polyethylene (LLDPE) having a density of from 0.900 to 0.930 g/cc, from 0.905 to 0.925 g/cc, or from 0.910 to 0.925 g/cc and a melt index (I₂) of from 0.2 to 5.0 g/10 mins, from 0.5 to 2.5 g/10 mins, from 0.75 to 1.5 g/10 mins, or from 0.9 to 1.2 g/10 mins. In embodiments, the multilayer PE film can include a low density polyethylene (LDPE) having a density of from 0.910 to 0.935 g/cc, from 0.915 to 0.935 g/cc, or from 0.920 to 0.930 g/cc and a melt index (I₂) of from 0.3 to 5.0 g/10 mins, from 0.5 to 2.5 g/10 mins, or from 0.6 to 1.0 g/10 mins.

Commercially available ethylene-based polymers that can be used in various embodiments of the multilayer PE film include those available under the tradenames ELITE, including ELITE™ AT 6202, DOWLEX™, including DOWLEX™ 2049G, and DOW™, including DOW™ LDPE 450E, all available from The Dow Chemical Company (Midland, Mich.).

The multilayer PE film 108 can be a cast film or a blown film. In some particular embodiments, the multilayer PE film 108 is a blown film. Such films can be formed using techniques known to those of skill in the art. For examples, the layers of the multilayer PE film 108 can be coextruded as a blown film or cast film. Blown film manufacturing lines and cast film manufacturing lines can be configured to coextrude multilayer PE films in a single extrusion step using techniques known to those of skill in the art based on the compositions of the different film layers.

The multilayer PE film 108 of various embodiments can advantageously provide desirable seal properties, such as a heat seal strength and a heat seal initiation temperature. In embodiments, the multilayer PE film 108 exhibits a heat seal initiation temperature of 115° C. or less, or 110° C. or less. For exle, the multilayer PE film 108 can have a heat seal initiation temperature of from 75 to 115° C., or from 80 to 110° C.

Multilayer Laminates

The various layers of the multilayer laminate 100 may be formed and oriented (for example, biaxially oriented) by any suitable process. Information about these processes may be found in reference texts such as, for example, the Kirk Othmer Encyclopedia, the Modern Plastics Encyclopedia, or the Wiley Encyclopedia of Packaging Technology, 2d edition, A. L. Brody and K. S. Marsh, Eds., Wiley-Interscience (Hoboken, 1997). For example, the layers of the multilayer laminate 100 may be formed through dipcoating, film casting, sheet casting, solution casting, compression molding, injection molding, lamination, melt extrusion, blown film including circular blown film, extrusion coating, tandem extrusion coating, or any other suitable procedure. In some embodiments, the films are formed by a melt extrusion, melt coextrusion, melt extrusion coating, or tandem melt extrusion coating process. In some embodiments, the films are formed by thermal lamination or extrusion lamination and coating. Films may be oriented using suitable orientation processes, such as tenter frame technology and machine-direction orientation (MDO) technology.

The thickness of the multilayer laminate 100 and the thickness of the various layers and sublayers (if any) of the multilayer laminate 100 can vary widely. Typically, the thickness of the multilayer laminate 100 is from 0.3 to 6.0 mil (from 8 to 152 μm). For example, the thickness of the multilayer laminate 100 can be from 0.8 to 4.0 mil (from 20 to 100 μm), or from 1.0 to 3.0 mil (from 25 to 76 μm). Each individual layer can have a thickness of from 0.3 to 4 mil (from 8 to 100 μm), from 0.3 mil to 3.0 mil (from 8 to 76 μm), from 0.4 to 2.0 mil (from 10 to 50 μm), from 0.5 to 3.0 mil (from 12 to 76 μm), from 0.5 to 1.2 mil (from 12 to 30 μm), or from 0.8 to 2.0 mil (from 20 to 50 μm). The thickness of any particular layer or sublayer will vary with, among other things, the composition and purpose of the sublayer.

The various layers of the multilayer laminate 100 can be laminated to adjacent layers using techniques known to those having ordinary skill in the art based on the teachings herein, including thermal lamination, dry lamination, adhesive lamination, solvent-less lamination, and other techniques.

In embodiments, one or more adhesives may be used to adhere one or more layers to one or more adjacent layers. Suitable adhesives can include, for example, solvent-based adhesives, solventless adhesives, water-based adhesives, and combinations thereof. Adhesives may be, for example, polyurethane, epoxy, or acrylic adhesives, or the like. In embodiments, the adhesives may be one-part or two-part formulations. In embodiments including adhesives, one or more different adhesives may be used to adhere layers to one another. The weight or thickness of the adhesive layer can depend on a number of factors including, for example, the desired thickness of the multilayer structure, the type of adhesive used, and other factors. In some embodiments, the adhesive layer is applied at up to 5.0 g/m², or from 1.0 to 4.0 g/m², or from 2.0 to 3.0 g/m².

It should be understood that any of the layers within a multilayer laminate 100 of the various embodiments described herein can further comprise one or more additives as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

In various embodiments, the multilayer laminate may have an acid resistance of pH<4 for 1 month (40° C. at 70% R.H). For example, the multilayer laminate may exhibit no delamination after exposure to an acid having a pH of less than 4.0, less than 3.75, or less than 3.5 for 1 month at a temperature of 40° C. at 70% relative humidity.

In various embodiments, the multilayer laminate exhibits a boiling resistance of at least 105° C. for 30 minutes. For example, the multilayer laminate may exhibit no delamination after being placed in an autoclave for sterilization at a temperature of at least 105° C. or at least 110° C. for 30 minutes.

Articles

In various embodiments, the multilayer laminates 100 disclosed herein can be used to form articles such as packages. Such articles can be formed from any of the multilayer laminates 100 described herein. Examples of packages that can be formed from multilayer laminates 100 of various embodiments can include flexible packages, sachets, pouches, stand-up pouches, and pre-made packages or pouches. In some embodiments, multilayer laminates 100 described herein can be used for food packages, such as packages for meats, cheeses, cereal, nuts, juices, sauces, and the like. Such packages can be formed using techniques known to those of skill in the art based on the teachings herein and based on the particular use for the package (e.g., type of food, amount of food, etc.).

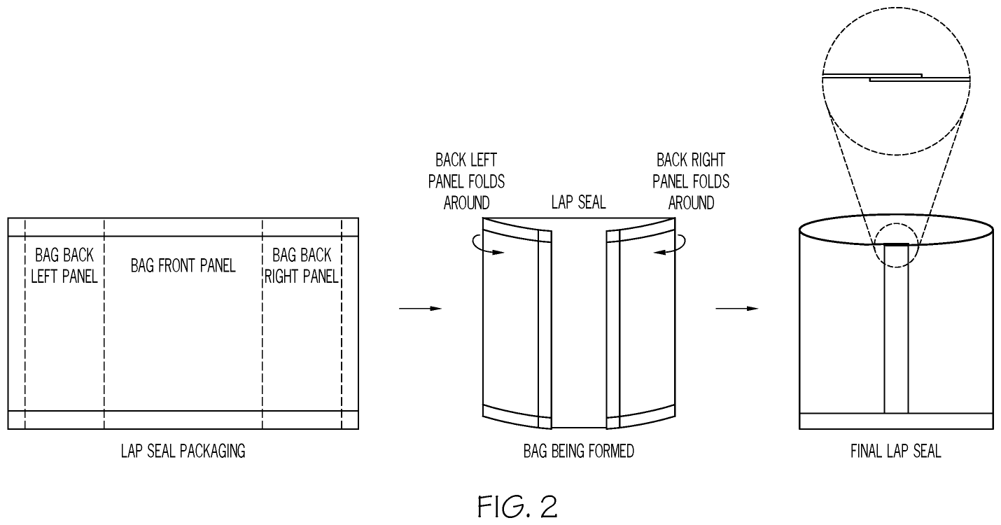

Articles made from the multilayer laminates 100 disclosed herein can include various types of seals, such as fin- or lap-seals (to form a tube of a pouch) and end-seals (to close the pouch on both ends). Lap seals are formed by overlapping the inside layer (i.e., the multilayer PE film 108) of the structure and the outside surface of the structure (i.e., the oriented polyethylene film 102) and heat sealing them, as shown in FIG. 2. Fin seals are formed when the inside surfaces (i.e., the multilayer PE film 108) of the structure meet and seal against themselves, typically in the back center of the bag. Lap seals provide material savings, compared to fin seals, because of not having to create folds.

In embodiments, the article is a flexible package including a lap-seal comprising the oriented polyethylene film 102 sealed to the multilayer PE film 108.

### Testing Methods

The test methods include the following:

Melt Index (MI)

Melt index (MI) were measured in accordance with ASTM D-1238 at 190° C. at 2.16 kg. The values are reported in g/10 min, which corresponds to grams eluted per 10 minutes.

Density

Samples for density measurement were prepared according to ASTM D4703 and reported in grams/cubic centimeter (g/cc or g/cm³). Measurements were made within one hour of sample pressing using ASTM D792, Method B.

Heat Seal Strength

Heat seal strength is measured according to ASTM F2029-00 (practice B, web sealability).

Heat Seal Initiation Temperature

Heat Seal Initiation Temperature (HSIT) (° C.) is determined according to ASTM F2029-00 with a visual inspection of the resulting heat seal curve for the determination of temperature at which the seal strength curve rises higher than 2 N/15 mm.

### EXAMPLES

The following examples illustrate features of the present disclosure but are not intended to limit the scope of the disclosure.

Polymers/Film Used

The following compositions included in the multilayer examples discussed below:

ELITE™ AT6202 is an enhanced LLDPE having a melt index of 0.85 g/10 min as measured in accordance with ASTM D1238 (190° C., 2.16 kg) and a density of 0.908 g/cc as measured in accordance with ASTM D792, available from The Dow Chemical Company (Midland, Mich.);

DOWLEX™ 2049G is a LLDPE having a melt index of 1.0 g/10 min as measured in accordance with ASTM D1238 (190° C., 2.16 kg) and a density of 0.926 g/cc as measured in accordance with ASTM D792, available from The Dow Chemical Company (Midland, Mich.);

DOW™ LDPE 450E is a LDPE having a melt index of 2 g/10 min as measured in accordance with ASTM D1238 (190° C., 2.16 kg) and a density of 0.923 g/cc as measured in accordance with ASTM D792, available from The Dow Chemical Company (Midland, Mich.);

The TF-BOPE, which has a commercial name of Decro DL25, was a 25 μm film commercially available from Decro subjected on one side to a corona treatment;

HS R719 is an ink available from DIC Corporation;

Al-foil was a 7 μm foil available from Daya (Jiangsu, China);

PET was a 12 μm PET film available from Shuang Xing (Jiangsu, China);

ADCOTE™ 811A/Coreactant F was a bi-component solvent-based adhesive (10/1) available from DOW Adhesives; and

LX500/KW75 was a bi-component solvent-based adhesive (8/1) available from DIC.

A multilayer PE film was a blown film manufactured on a blown film line from Jinming Machinery in Shanghai using a 7-layer (A/B/C/D/E/F/G) pancake with a die diameter of 120 mm, a die gap of 1.5 mm, and an output of approximately 25 kg/hour. The blown film line had a blow up ratio (BUR) of 2.3 (layflat before stretching was 43 cm), a first haul off speed of 5.7 m/min, an extruder diameter of 30 mm, and an L/D of 30. The split winding was online. The die temperature profiles, extruder temperature profiles, and detailed formulations are shown in Table 1 below. The resultant PE film was a 45 μm film with layer ratio of 1/1/1.

TABLE 1
Blown multilayer PE film

| | Die | | |
|---|---|---|---|
| | Temperature | Extruder Temperature | Formulation |
| A | 215° C. | 170/205/210/210/ | 80% ELITE ™ AT6202 + |
| B | | 210° C. | 20% LDPE 450E + slip* + |
| | | | AB** |
| C | 220° C. | 190/210/220/220/ | 50% DOWLEX ™ 2049G + |
| D | | 220° C. | 50% LDPE 450E |
| E | | | |
| F | 215° C. | 170/205/210/210/ | 50% DOWLEX ™ 2049G + |
| G | | 210° C. | 50% LDPE 450E |

*slip is a slip agent
**AB is an anti-block agent

Ink was applied to the print layer (TF-BOPE in Comparative Examples A and B and PET in Examples 1 and 2) using a rotogravure printing process. In particular, the films were reverse printed on a Rotomac 8 rotogravure color printing machine having a print speed of 100 meters/min. 100?

After printing, the layers of the multilayer laminate were laminated according to the structures in Table 2 using a Nordmeccanica solventless laminator at a speed of 200 meters/min. Comparative Example A and Example 1 included ADCOTE' 811A/Coreactant F adhesive and Comparative Example B and Example 2 included LX500/KW75 adhesive. The coat weight of adhesive for each layer was 4 g/m², and the multilayer laminates were cured in a 40° C. oven for 60 hours.

TABLE 2
Laminate Structures

| | Laminate Structure | Print Layer |
|---|---|---|
| Comp. Example A | TF-BOPE-ink//Al-foil//PET//B-PE | TF-BOPE |
| Comp. Example B | TF-BOPE-ink//Al-foil//PET//B-PE | TF-BOPE |
| Example 1 | TF-BOPE//PET-ink//Al-foil/B-PE | PET |
| Example 2 | TF-BOPE//PET-ink/Al-foil//B-PE | PET |

The multilayer laminates were subjected to a sterilization test by placing the laminates into an autoclave for sterilization at various temperatures for 30 minutes. The results are reported in Table 3.

TABLE 3
Summary of Sterilization Testing Results

| | 30 minutes | 30 minutes | 30 minutes | 30 minutes |
|---|---|---|---|---|
| Sample | @ 95° C. | @ 100° C. | @ 105° C. | @ 110° C. |
| Comp. | Delamination | Delamination | Delamination | Delamination |
| Example A | | | | |
| Comp. | No issue | No issue | No issue | Delamination |
| Example B | | | | |
| Example 1 | No issue | No issue | No issue | Delamination |
| Example 2 | No issue | No issue | No issue | No issue |

As demonstrated by the data in Table 3, Examples 1 and 2 demonstrated improved boiling resistance over Comparative Examples A and B, respectively, indicating that improved boiling resistance could be achieved by changing the printing layer from the TF-BOPE layer (Comparative Examples A and B) to the PET layer (Examples 1 and 2), and changing the lamination sequence to position the barrier layer between the multilayer PE film and the PET layer.

The acid resistance of Comparative Examples A and B and Examples 1 and 2 were measured by placing the laminates into a bottle with an acid solution and placing the bottle into a 40° C. oven at 70% relative humidity for one month, and the results are reported in Table 4. Each example was sterilized for 30 minutes at 105° C. prior to immersion in the solution in Table 4.

TABLE 4
Acid Resistance Testing Results

| | Acetic acid | Acetic acid | Acetic acid | Energy |
|---|---|---|---|---|
| | (aq) | (aq) | (aq) | Engine* |
| Sample | pH = 2.51 | pH = 3.49 | pH = 4.54 | (pH = 3.64) |
| Comp. | Delamination | Delamination | No issue | No issue |
| Example A | | | | |
| Comp. | Delamination | Delamination | Delamination | Delamination |
| Example B | | | | |
| Example 1 | Delamination | No issue | No issue | No issue |
| Example 2 | Delamination | Delamination | Delamination | No issue |

*Energy Engine is a healthcare product, available from Bi-Health (Guangdong, China)

As shown in Table 4, Example 2 demonstrated the best acid resistance performance, and survived each of the solutions except for the acid solution with a pH of 2.51 for one month. Comparative Example B demonstrated the worst acid resistance performance, failing each of the tests. Comparing Examples 1 and 2 to Comparative Examples A and B, respectively, demonstrates that changing of the printing layer and lamination sequence improves the acid resistance of the multilayer laminate.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A multilayer laminate comprising:
an oriented polyethylene film;
a biaxially oriented film adhered to the oriented polyethylene film and comprising one or more components selected from biaxially oriented polyamide (BOPA), biaxially oriented polyethylene terephthalate (BOPET), and biaxially oriented polypropylene (BOPP), wherein the biaxially oriented film comprises ink;
a barrier film adhered to the biaxially oriented film, wherein the barrier film comprises a metal layer, silica-coated layer, or metallized film; and
a multilayer polyethylene (PE) film adhered to the barrier film.

2. The multilayer laminate of claim 1, wherein the multilayer laminate comprises an adhesive, the adhesive comprising one or more adhesives selected from solvent-based adhesive, solventless adhesive, and water-based adhesive.

3. The multilayer laminate of claim 2, wherein the adhesive comprises solvent-based adhesive.

4. The multilayer laminate of claim 1, wherein the barrier film comprises one or more components selected from aluminum foil, metallized polyethylene terephthalate (mPET), silica-coated polyethylene terephthalate (silica-coated PET), metallized oriented polypropylene (mOPP), and metallized cast polypropylene (mCPP).

5. The multilayer laminate of claim 1, wherein the biaxially oriented film comprises BOPET.

6. The multilayer laminate of claim 1, wherein the barrier film is a multilayer or monolayer film.

7. The multilayer laminate of claim 1, wherein the barrier film comprises aluminum foil.

8. The multilayer laminate of claim 1, wherein the multilayer PE film comprises at least one layer comprising low density polyethylene (LDPE) and linear low density polyethylene (LLDPE).

9. The multilayer laminate of claim 1, wherein the multilayer PE film is a blown film.

10. The multilayer laminate of claim 1, wherein the oriented polyethylene film comprises tenter frame biaxially oriented polyethylene (TF-BOPE) film.

11 . A flexible package comprising the multilayer laminate of claim 1, wherein the flexible package comprises a lap seal, the lap seal comprising the oriented polyethylene film sealed to the multilayer PE film.
